(19) United States
(12) Patent Application Publication
(10) Pub. No.: US 2024/0377215 A1
(43) Pub. Date: Nov. 14, 2024

(54) MAP INFORMATION STORAGE DEVICE, STORAGE MEDIUM STORING COMPUTER PROGRAM FOR MAP INFORMATION STORAGE, AND MAP INFORMATION STORAGE METHOD

(71) Applicant: WOVEN BY TOYOTA, INC., Tokyo (JP)

(72) Inventors: Masaki TAKANO, Susono-shi (JP); Yusaku Mandai, Tokyo-to (JP)

(73) Assignee: WOVEN BY TOYOTA, INC., Tokyo (JP)

(21) Appl. No.: 18/593,093

(22) Filed: Mar. 1, 2024

(30) Foreign Application Priority Data
May 10, 2023 (JP) 2023-077970

(51) Int. Cl. G01C 21/36; B60W 60/00

(52) U.S. Cl. CPC G01C 21/3658; B60W 60/001; B60W 2552/30; B60W 2552/53; B60W 2556/40

(57) ABSTRACT

A map information storage device stores map information which includes information relating to traffic lanes shown as a series of multiple lane position information items, and has a storage device that stores lane position information items in a number necessary for control of a vehicle, for a first zone oriented from a current location of the vehicle toward a traveling direction of the vehicle, and stores lane position information items in a number necessary to verify the end of a region where map information is provided and in a number less than the number necessary for control of the vehicle, for a second zone oriented from an end of the first zone toward the traveling direction of the vehicle.

### FIELD

The present disclosure relates to a map information storage device, a storage medium storing a computer program for map information storage, and a map information storage method.

### BACKGROUND

An automatic control system for a vehicle uses high-precision map information for a predetermined zone including the current location of the vehicle, for control of the vehicle (see Japanese Unexamined Patent Publication No. 2021-192011, for example). The automatic control system receives high-precision map information for the predetermined zone including the current location of the vehicle from a server, and stores it.

The high-precision map information includes information representing traffic lanes, road curvature and other road features, the majority of which is information relating to traffic lanes. Traffic lanes are represented by a series of lane position informational items representing the positions of the lanes.

Since the automatic control system cannot control the vehicle in regions where high-precision map information is not available, the vehicle is caused to travel while verifying the end of each region where high-precision map information is provided.

### SUMMARY

Storing all of the information from the current location of the vehicle to the end of each region where high-precision map information is provided has required a storage unit with massive memory capacity. However, merely verifying the end position of a region where high-precision map information is provided does not require all of the high-precision map information up to the end of that region.

It is therefore an object of the present disclosure to provide a map information storage device that can store map information with fewer items of information needed for verifying the end of a region where map information is provided.

(1) According to one embodiment of the invention there is provided a map information storage device. The map information storage device is a map information storage device that stores map information which includes information relating to traffic lanes shown as a series of multiple lane position information items, and has a storage device that stores lane position information items in a number necessary for control of a vehicle, for a first zone oriented from a current location of the vehicle toward a traveling direction of the vehicle, and stores lane position information items in a number necessary to verify the end of a region where map information is provided and in a number less than the number necessary for control of the vehicle, for a second zone oriented from an end of the first zone toward the traveling direction of the vehicle.

(2) In the map information storage device of embodiment (1) above, it is preferable that the storage device stores lane position information representing left and right lane marking lines delineating a traffic lane, for the first zone, and stores lane position information representing any lines from among the left lane marking line and right lane marking line delineating the traffic lane, and a center line representing the center of the traffic lane, for the second zone.

(3) In the map information storage device of embodiment (2) above, it is preferable that the storage device stores information representing a distance from the end of the first zone to an end of the second zone represented by the lane position information items, and the map information storage device further has a processor configured to determine that the end of the second zone is the end of the region where map information is provided, when a distance from the current location of the vehicle to the end of the second zone is less than a predetermined reference distance.

(4) In the map information storage device of embodiment (3) above, it is preferable that the traffic lanes for the first zone and second zone are represented by a series of traffic lane zones, and the storage device stores each of lengths of the traffic lane zones, and a distance from a start of the first zone to the end of the second zone is represented as sum of each of the lengths of the traffic lane zones between the start of the first zone and the end of the second zone.

(5) In the map information storage device of any of embodiments (1) to (4) above, it is preferable that the lane position information of the second zone includes curvature at a location of the traffic lane having curvature exceeding a predetermined threshold.

(6) The map information storage device of any of embodiments (1) to (5) above, it is preferable that the map information storage device further has an input device that inputs lane position information items in the number necessary for control of the vehicle for the first zone, and inputs lane position information items in the number necessary to verify the end of the region where map information is provided, for the second zone, and wherein the storage device stores the lane position information items in the number necessary for control of the vehicle input by the input device for the first zone, and stores the lane position information items in the number necessary to verify the end of the region where map information is provided and in the number less than the number necessary for control of the vehicle, input by the input device, for the second zone.

(7) The map information storage device of any of embodiments (1) to (5) above, it is preferable that the map information storage device further has a processor configured to input lane position information items in the number necessary for control of the vehicle for the first zone and second zone, acquire lane position information items in the number necessary for control of the vehicle for the first zone, and acquire lane position information items in the number necessary to verify the end of the region where map information is provided, for the second zone, and wherein the storage device stores the acquired lane position information items in the number necessary for control of the vehicle, for the first zone, and stores the acquired lane position information items in the number necessary to verify the end of the region where map information is provided and in the number less than the number necessary for control of the vehicle, for the second zone.

(8) According to another embodiment, a storage medium storing a computer program for map information storage is provided. The computer program for map information storage stores map information which includes information relating to traffic lanes shown as a series of multiple lane position information items, and causes a processor to execute a process and the process includes inputting lane position information items in a number necessary for control of a vehicle for a first zone oriented from a current location of the vehicle toward a traveling direction of the vehicle, and inputting lane position information items in a number necessary to verify an end of a region where map information is provided, for a second zone oriented from an end of the first zone toward a traveling direction of the vehicle, and storing the lane position information items in the number necessary for control of the vehicle for the first zone in a storage unit, and storing the lane position information items in a number necessary to verify the end of the region where map information is provided and in a number less than the number necessary for control of the vehicle, for the second zone, in the storage unit.

(9) According to yet another embodiment there is provided a map information storage method. The map information storage method is a method for storage of map information which includes information relating to traffic lanes shown as a series of multiple lane position information items, and the method is carried out by a map information storage device and the method includes inputting lane position information items in a number necessary for control of a vehicle for a first zone oriented from a current location of the vehicle toward a traveling direction of the vehicle, and inputting lane position information items in a number necessary to verify an end of a region where map information is provided, for a second zone oriented from an end of the first zone toward a traveling direction of the vehicle, and storing the lane position information items in the number necessary for control of the vehicle for the first zone in a storage unit, and storing the lane position information items in a number necessary to verify the end of the region where map information is provided and in a number less than the number necessary for control of the vehicle, for the second zone, in the storage unit.

The map information storage device of the present disclosure can store map information with fewer items of information needed for verifying the end of a region where map information is provided.

The object and advantages of the invention will be realized and attained by means of the elements and combinations particularly specified in the claims. It is to be understood that both the foregoing general description and the following detailed description are exemplary and explanatory and are not restrictive of the invention as claimed.

### BRIEF DESCRIPTION OF DRAWINGS

FIG. 1 is a diagram illustrating operation of a map information storage device of the embodiment in overview.

FIG. 2 is a sequence diagram relating to map information storage processing by a map information storage system that includes a map information storage device of the embodiment.

FIG. 3 is a general schematic drawing of a vehicle in which the map information storage device of the embodiment is mounted.

FIG. 4 is a hardware configuration diagram for a server of the embodiment.

FIG. 5 is an example of an operation flow chart for storage processing by the map information storage device of the embodiment.

FIG. 6A is a diagram illustrating a road zone management table.

FIG. 6B is a diagram illustrating a traffic lane zone management table.

FIG. 7A is a diagram showing some of the traffic lane zones in the first zone.

FIG. 7B is a diagram showing multiple traffic lane zones in the second zone.

FIG. 8 is an example of an operation flow chart for determination processing by the map information storage device of the embodiment.

FIG. 9 is an example of an operation flow chart for send processing by the server.

FIG. 10 is a diagram illustrating a modified example of a map information storage device of the embodiment.

### DESCRIPTION OF EMBODIMENTS

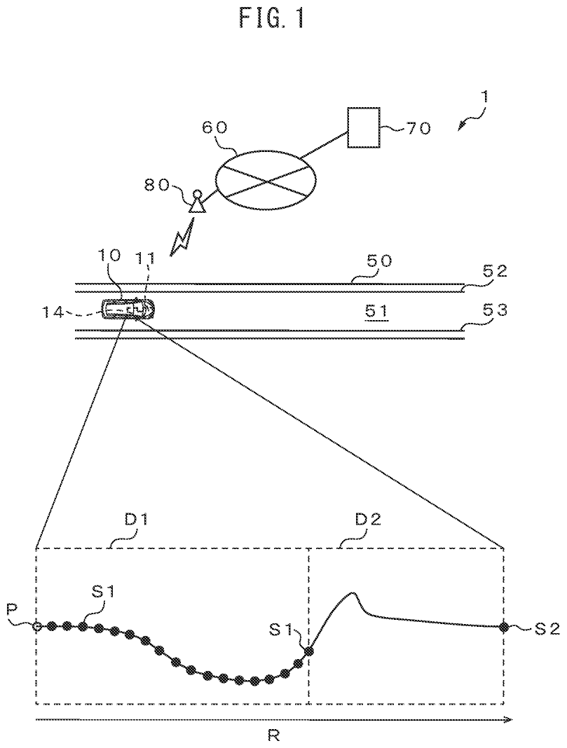

FIG. 1 is a diagram illustrating operation of a map information storage device 11 of the embodiment in overview. The map information storage system 1 comprising the map information storage device 11 of the embodiment has at least a vehicle 10 and a server 70.

The vehicle 10 accesses a wireless base station 80 (hereunder also referred to as macrocell base station 80), whereby it is connected with the server 70 via the macrocell base station 80 and a communication network 60. The macrocell base station 80 is connected with the communication network 60 via a gateway (not shown).

Although only one vehicle 10 is depicted in FIG. 1, the map information storage system 1 may have more than one vehicle 10. Likewise, more than one macrocell base station 80 may be connected to the communication network 60.

The map information storage device 11 and automatic control device 14 are mounted in the vehicle 10. The map information storage device 11 stores map information to be used to estimate the current location of the vehicle 10. The map information includes information representing traffic lanes, road curvature and other road features.

The automatic control device 14 has a self-driving mode in which the vehicle 10 is driven primarily by the automatic control device 14, and a manual driving mode in which the vehicle 10 is driven primarily by the driver. The vehicle 10 is currently being driven in self-driving mode by the automatic control device 14.

In the example shown in FIG. 1, the vehicle 10 is traveling in a traffic lane 51 of a road 50. The traffic lane 51 is delineated by a lane marking line 52 and a lane marking line 53. The navigation route R of the vehicle 10 indicates traveling on the road 50.

Lane marking lines are represented in the map information as a series of multiple points. Each point location is represented as coordinates with latitude and longitude on a world coordinate system, for example. Throughout the present specification, information representing point locations indicating lane marking lines will also be referred to as “lane position information”. The lane position information may also include information representing height in addition to latitude and longitude.

The map information storage device 11 outputs the map information including the current location of the vehicle 10 to the automatic control device 14. The automatic control device 14 controls the vehicle while estimating the location of the vehicle 10 based on the map information. As the vehicle 10 moves, the map information storage device 11 also receives high-precision map information in a predetermined range including the current location of the vehicle 10 from the server 70, and stores it.

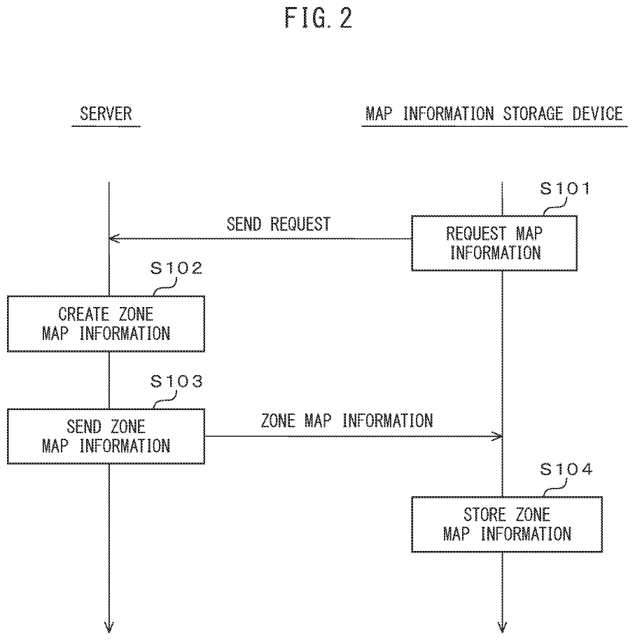

FIG. 2 is a sequence diagram relating to map information storage processing by a map information storage system 1 that includes the map information storage device 11 of the embodiment. The map information storage system 1 carries out map information storage processing according to the sequence diagram shown in FIG. 2, each time it receives a send request for sending of map information from the vehicle 10.

First, the map information storage device 11 sends a send request for sending of map information, together with the current location P of the vehicle 10 and navigation route R, to the server 70 via the macrocell base station 80 and communication network 60, at a map information update time set with a predetermined cycle (step S101).

The server 70 then creates zone map information based on the current location P of the vehicle 10, the navigation route R and the high-precision map information of the server 70 (step S102). The zone map information includes high-precision map information for the predetermined range from the current location P of the vehicle 10 toward the traveling direction of the vehicle 10. The range of the zone map information changes as the vehicle 10 moves. The high-precision map information is provided to the server 70 by a cartographer.

The server 70 then sends the zone map information to the map information storage device 11, via the communication network 60 and macrocell base station 80 (step S103).

The map information storage device 11 receives the zone map information and stores it (step S104), and the series of processing steps is complete. In the first zone D1 from the current location P of the vehicle 10 toward the traveling direction of the vehicle 10, the zone map information has lane position information items in the number necessary for the automatic control device 14 to control the vehicle 10 along the navigation route R. The end position of the first zone D1 is, for example, a location between 200 m and 400 m from the current location P of the vehicle 10.

As shown in FIG. 1, the lane marking lines 52, 53 are represented as a series of multiple points S1, as the zone map information for the first zone D1. In actuality, the zone map information for the first zone D1 has lane position information representing a series of pairs of points representing the lane marking lines 52, 53, but in FIG. 1 the pairs of points are shown only as points S1.

The multiple points S1 are provided in a number which allows the automatic control device 14 to control the vehicle 10 along the navigation route R. The location of each point S1 is represented in the lane position information. The zone map information for the first zone D1 includes lane position information for the multiple points S1 representing the locations of the lane marking lines 52, 53 between the start and end of the first zone D1.

As the vehicle 10 moves, the map information storage device 11 outputs map information for a relatively narrow region including the current location of the vehicle 10, among the zone map information included in the first zone D1, to the automatic control device 14. The automatic control device 14 controls the vehicle 10 based on the map information.

In the second zone D2 from the end of the first zone D1 toward the traveling direction of the vehicle 10, the zone map information has high-precision lane position information items only in the number necessary to verify the end of the region where map information is provided. The zone map information has lane position information items in less than the number necessary to control the vehicle 10.

The end of the second zone D2 is usually a location ahead of the current location P of the vehicle 10 by a distance determined by the map end. The map end determining distance is the distance during which it is determined whether or not map information is provided ahead from the current location P of the vehicle 10 in the traveling direction. The map end determining distance may be 700 m to 1000 m, for example. The zone map information for the second zone D2 does not have lane position information items in the number necessary to cause the vehicle 10 to travel along the navigation route.

In the example shown in FIG. 1, the zone map information for the second zone D2 includes a lane position information item point S2 representing the location of the lane marking lines 52, 53 at the end of the second zone D2. The zone map information for the second zone D2 does not include lane position information items representing the lane marking lines 52, 53 at any locations other than the end of the second zone D2.

When high-precision map information from the end of the first zone D1 up to the location of the map end determining distance has been provided, the server 70 creates zone map information for the second zone D2 from the end of the first zone D1 up to the location of the map end determining distance, based on the high-precision map information.

When zone map information received from the server 70 includes lane position information for the end position of the second zone D2, the map information storage device 11 determines that high-precision map information has been provided from the current location P of the vehicle 10 up to the end of the second zone D2.

When the vehicle 10 is to move from a region where high-precision map information is provided into a region where high-precision map information is not provided; however, it may be that high-precision map information has not been provided at the location ahead from the current location P of the vehicle 10 by the map end determining distance.

In this case, the server 70 creates zone map information for the second zone D2, based on map information up to the end where high-precision map information has been provided, and therefore the end of the zone map information for the second zone D2 matches the end of the region where high-precision map information is provided.

When the zone map information for the second zone D2 received from the server 70 does not include lane position information for the position ahead from the current location P of the vehicle 10 by the map end determining distance, the map information storage device 11 determines that the end of the second zone D2 represents the end of the region where high-precision map information is provided.

When it has been determined that the end of the second zone D2 represents the end of the region where high-precision map information has been provided, the map information storage device 11 gives the automatic control device 14 an end notification, indicating that self-driving mode is to end. The automatic control device 14 transfers to manual driving mode before the vehicle 10 reaches the end of the region where high-precision map information has been provided.

It is sufficient for the zone map information for the second zone D2 to have lane position information items only in the number necessary to verify the end of the region where high-precision map information is provided. The zone map information for the second zone D2 does not need to have numerous lane position information items as for the first zone D1, since it is not used to cause the vehicle 10 to travel along the navigation route R. The map information storage device 11 can therefore greatly decrease storage of lane position information items, which requires large memory capacity.

As explained above, the map information storage device 11 of the embodiment can store map information with fewer items of information needed for verifying the location of the end of a region where high-precision map information is provided.

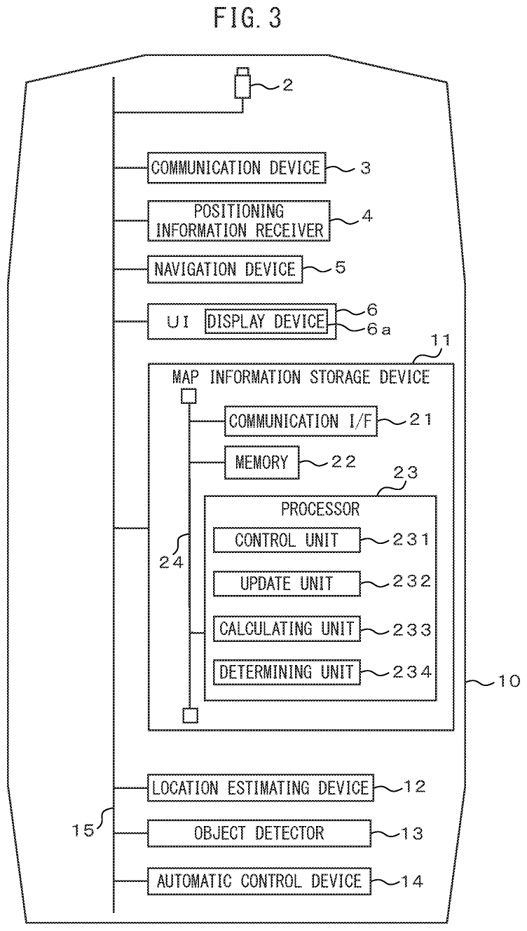

FIG. 3 is a general schematic drawing of a vehicle 10 in which the map information storage device 11 of the embodiment is mounted. The vehicle 10 has a camera 2, a communication device 3, a positioning information receiver 4, a navigation device 5, a user interface (UI) 6, a map information storage device 11, a location estimating device 12, an object detector 13 and an automatic control device 14. The vehicle 10 may also have a LiDAR sensor, as a distance sensor (not shown) for measurement of the distance of the vehicle 10 to surrounding objects.

The camera 2, communication device 3, positioning information receiver 4, navigation device 5, UI 6, map information storage device 11, location estimating device 12, object detector 13 and automatic control device 14 are connected in a communicable manner through an in-vehicle network 15 that conforms to controller area network standards.

The camera 2 is an example of an imaging unit provided in the vehicle 10. The camera 2 is mounted inside the vehicle 10 and directed toward the front of the vehicle 10. The camera 2, for example, takes a camera image in which the environment of a predetermined region ahead of the vehicle 10 is shown, at a predetermined cycle. The camera image can show the road in the predetermined region ahead of the vehicle 10, and road features such as surface lane marking lines on the road. The camera 2 has a 2D detector composed of an array of photoelectric conversion elements with visible light sensitivity, such as a CCD or C-MOS, and an imaging optical system that forms an image of the photographed region on the 2D detector.

Each time a camera image is taken, the camera 2 outputs the camera image and the camera image photograph time at which the camera image was taken, through the in-vehicle network 15 to the location estimating device 12 and object detector 13. The camera image is also used for processing at the location estimating device 12 to estimate the location of the vehicle 10. At the object detector 13, the camera image is used for processing to detect objects surrounding the vehicle 10.

The communication device 3 is an example of a device communication unit, and it has an interface circuit for connecting the map information storage device 11 and other devices to a macrocell base station 80. The communication device 3 is configured in a communicable manner with the server 70 via the macrocell base station 80 and communication network 60.

The positioning information receiver 4 outputs positioning information that represents the current location of the vehicle 10. The positioning information receiver 4 may be a GNSS receiver, for example. The positioning information receiver 4 outputs positioning information and the positioning information acquisition time at which the positioning information has been acquired, to the navigation device 5 and map information storage device 11, each time positioning information is acquired at a predetermined receiving cycle.

Based on the navigation map information, the destination location of the vehicle 10 input through the UI 6, and positioning information representing the current location of the vehicle 10 input from the positioning information receiver 4, the navigation device 5 creates a navigation route R from the current location to the destination location of the vehicle 10. The navigation route R includes information relating to the locations of right turns, left turns, merging and branching. In the navigation map, roads are represented as multiple road links connected by nodes. Each of the nodes and road links is identified using identification information. The locations of the road links and nodes are represented on a world coordinate system where the origin is a predetermined location, for example. When the destination location has been newly set or the current location of the vehicle 10 has exited the navigation route R, the navigation device 5 creates a new navigation route R for the vehicle 10. Every time a navigation route R is created, the navigation device 5 outputs the navigation route R to the map information storage device 11 and location estimating device 12, via the in-vehicle network 15.

The UI 6 is an example of the notification unit. The UI 6, controlled by the navigation device 5 and automatic control device 14, etc., notifies the driver of the vehicle 10 traveling information and an end notification indicating that self-driving mode is to end. The traveling information of the vehicle 10 includes information relating to the current location of the vehicle and the current and future route of the vehicle, such as the navigation route. The UI 6 may also have an acoustic output device (not shown) to notify the driver of traveling information. The UI 6 has a display device 6a such as a liquid crystal display or touch panel, for display of the traveling information.

The UI 6 also creates an operation signal in response to operation of the vehicle 10 by the driver. The UI 6 also has a touch panel or operating button, for example, as an input device for inputting operation information from the driver to the vehicle 10. The operation information may be, for example, a destination location, transit points, vehicle speed or other control information for the vehicle 10. The UI 6 outputs the input operation information to the navigation device 5 and the automatic control device 14, etc., via the in-vehicle network 15.

The map information storage device 11 carries out control processing, update processing, calculation processing and determination processing. For this purpose, the map information storage device 11 has a communication interface (IF) 21, a memory 22 and a processor 23. The communication interface 21, memory 22 and processor 23 are connected via signal wires 24. The communication interface 21 has an interface circuit to connect the map information storage device 11 with the in-vehicle network 15.

All or some of the functions of the map information storage device 11 are functional modules driven by a computer program operating on the processor 23, for example. The processor 23 has a control unit 231, an update unit 232, a calculating unit 233 and a determining unit 234. Alternatively, the functional module of the processor 23 may be a specialized computing circuit in the processor 23. The processor 23 comprises one or more CPUs (Central Processing Units) and their peripheral circuits. The processor 23 may also have other computing circuits such as a logical operation unit, numerical calculation unit or graphics processing unit. The memory 22 is an example of a storage unit, and it has a volatile semiconductor memory and a non-volatile semiconductor memory, for example. The memory 22 stores an application computer program and various data to be used for information processing carried out by the processor 23 of each device.

The memory 22 stores zone map information for location estimation in a relatively wide area including the current location of the vehicle 10, for the first zone D1. The zone map information has high-precision map information including three-dimensional information for the road surface, lane position information representing lane marking lines on the road, and information representing the types and locations of other road features and structures, as well as the legal speed limit for the road. The automatic control device 14 controls the vehicle 10 based on the high-precision map information stored in the memory 22. Driving of the vehicle 10 in self-driving mode by the automatic control device 14 is not permitted in regions where high-precision map information has not been provided. The memory 22 is an exemplary storage device.

For the second zone D2 the memory 22 has lane position information items in the number necessary to verify the end of the region where high-precision map information is provided.

Each time positioning information is input from the positioning information receiver 4, the control unit 231 refers to the stored wide-area zone map information and outputs map information for a relatively narrow area including the current location represented by the positioning information, through the in-vehicle network 15, to the location estimating device 12, the object detector 13 and the automatic control device 14. Operation of the map information storage device 11 will be described in detail below.

The location estimating device 12 estimates the location of the vehicle 10 at the camera image photograph time, based on the road features surrounding the vehicle 10 represented in the camera image. For example, the location estimating device 12 compares lane marking lines identified in the camera image with lane marking lines represented in the map information input from the map information storage device 11, and determines the estimated location and estimated declination of the vehicle 10 at the camera image photograph time. The location estimating device 12 estimates the road traveling lane where the vehicle 10 is located, based on the lane marking lines represented in the map information and on the estimated location and estimated declination of the vehicle 10. Each time the estimated location, estimated declination and traveling lane of the vehicle 10 are determined at the camera image photograph time, the location estimating device 12 outputs this information to the object detector 13 and automatic control device 14.

The object detector 13 detects objects around the vehicle 10 and their types (for example, vehicles) based on the camera image, for example. Objects also include other vehicles traveling around the vehicle 10. The object detector 13 tracks detected objects and determines the trajectories of the other objects. The object detector 13 identifies the traveling lanes in which the objects are traveling, based on the lane marking lines represented in the map information and the locations of the objects. The object detector 13 outputs object detection information which includes information representing the types of objects that were detected, information indicating their locations, and also information indicating their traveling lanes, to the automatic control device 14.

The automatic control device 14 has a self-driving mode wherein the vehicle 10 is driven primarily by the automatic control device 14 (for example, driving mode with levels 3 to 5) and a manual driving mode in which the vehicle 10 is driven primarily by the driver (for example, driving mode with levels 0 to 2).

In self-driving mode, the automatic control device 14 controls operations such as steering, actuation and braking of the vehicle 10, based on map information and on detection information from sensors, such as the camera 2, mounted in the vehicle 10. Control of the vehicle 10 in self-driving mode is permitted in regions where high-precision map information has been provided. In manual driving mode, the automatic control device 14 controls operation of the vehicle 10 including steering, actuation and braking based on manipulation by the driver 40. In regions where high-precision map information has not been provided, the vehicle 10 is controlled in manual driving mode.

In self-driving mode, the automatic control device 14 generates a traveling lane plan representing the scheduled traveling lane in which the vehicle 10 is to travel, based on the map information, the navigation route R and surrounding environment information, and the current location of the vehicle 10. The automatic control device 14 also creates a driving plan representing the scheduled traveling trajectory of the vehicle 10 up until a predetermined time, based on the traveling lane plan, the map information, the current location of the vehicle 10, the surrounding environment information and the vehicle status information. The automatic control device 14 then generates a driving plan so that the vehicle 10 travels in a traffic lane delineated by a pair of lane marking lines represented by lane position information. The automatic control device 14 controls steering, actuation and braking based on the current location of the vehicle 10, the vehicle speed and yaw rate, and the driving plan.

For FIG. 3, the map information storage device 11, location estimating device 12, object detector 13 and automatic control device 14 were explained as separate devices, but all or some of them may be constructed in a single device.

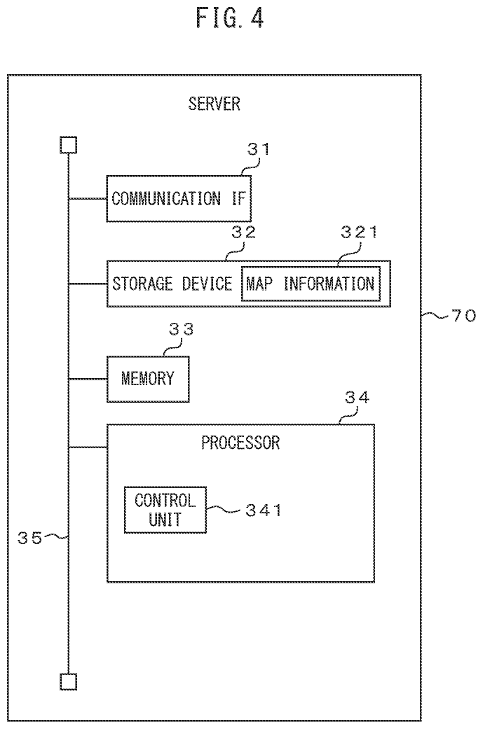

FIG. 4 is a hardware configuration diagram for the server 70. The server 70 carries out control processing. For this purpose, the server 70 comprises a communication interface (IF) 31, a storage device 32, a memory 33 and a processor 34. The communication IF 31, storage device 32 and memory 33 are connected with the processor 34 via signal wires 35. The server 70 may also has an input device such as a keyboard and mouse, and a display device such as a liquid crystal display.

The communication IF 31 has an interface circuit to connect the server 70 with the communication network 60. The communication IF 31 is configured in a communicable manner with the vehicle 10, via the communication network 60 and macrocell base station 80. The communication IF 31 is an example of a server communication unit.

The storage device 32 has, for example, a hard disk device or optical recording medium, and a device for accessing it. The storage device 32 stores map information 321 including navigation map and high-precision map information. The navigation map is the same map as for the navigation device 5 of the vehicle 10. The high-precision map information has lane position information items in the number necessary to control the vehicle 10. The high-precision map information has high-precision map information including three-dimensional information for the road surface, information representing the types and locations of other road features and structures, and the legal speed limit for the road. The high-precision map information is provided by a cartographer. The storage device 32 may still further store a computer program for carrying out processing by the server 70 related to map information storage processing, which is carried out in the processor 34. The storage device 32 is an example of a storage unit.

The memory 33 has a volatile semiconductor memory and a non-volatile semiconductor memory, for example. The memory 33 stores an application computer program and various data to be used for information processing carried out by the processor 34 of each device. Restriction information may also be stored in the memory 33. The memory 33 is also an example of a storage unit.

All or some of the functions of the server 70 are functional modules carried out by a computer program operating on the processor 34, for example. The processor 34 has a control unit 341. Alternatively, the functional module of the processor 34 may be a specialized computing circuit in the processor 34. The processor 34 comprises one or more CPUs (Central Processing Units) and their peripheral circuits. The processor 34 may also have other computing circuits such as a logical operation unit, numerical calculation unit or graphics processing unit. Operation of the server 70 will be described in detail below.

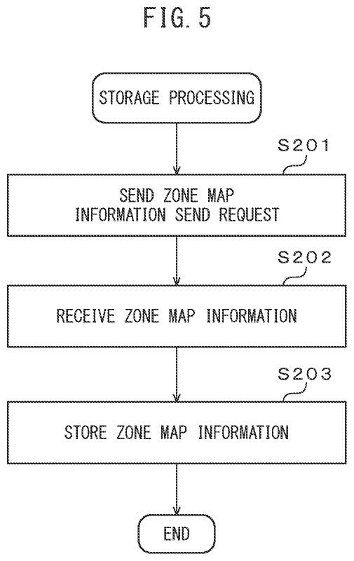

FIG. 5 is an example of an operation flow chart for storage processing by the map information storage device 11 of the embodiment. The map information storage device 11 carries out storage processing according to the operation flow chart shown in FIG. 5, at a map information update time set with a predetermined cycle.

First, the update unit 232 transmits a send request for sending of zone map information, to the server 70, together with the current location P of the vehicle 10 and the navigation route R (step S201). The server 70 refers to the high-precision map information, generates zone map information for the first zone D1 and second zone D2 based on the current location P of the vehicle 10 and navigation route R, and sends it to the map information storage device 11.

The update unit 232 then receives the zone map information from the server 70 (step S202). For the first zone D1, the update unit 232 receives the zone map information including lane position information items in the number necessary to control the vehicle 10. For the second zone D2 the update unit 232 receives zone map information including lane position information items in the number necessary to verify the end position of the region where map information is provided. The update unit 232 is an example of an input unit.

The update unit 232 then stores the zone map information in the memory 22 (step S203), and the series of processing steps is complete. For the first zone D1, the update unit 232 stores in the memory 22 the zone map information including lane position information items in the number necessary to control the vehicle 10. For the second zone D2 the update unit 232 stores in the memory 22 the zone map information including lane position information items in the number necessary to verify the end position of the region where high-precision map information is provided.

The roads in the zone map information are represented as a series of multiple road zones. Each of the road zones is identified using identification information. One or more traffic lanes in a road are associated with each one of the road zones. The locations of traffic lanes in the zone map information are represented on a world coordinate system where the origin is a predetermined location, for example. The zone map information has a road zone management table where information for road zones in the map information are registered. One traffic lane of the road is represented as a series of traffic lane zones. The zone map information has a traffic lane zone management table where information for traffic lane zones in the map information are registered.

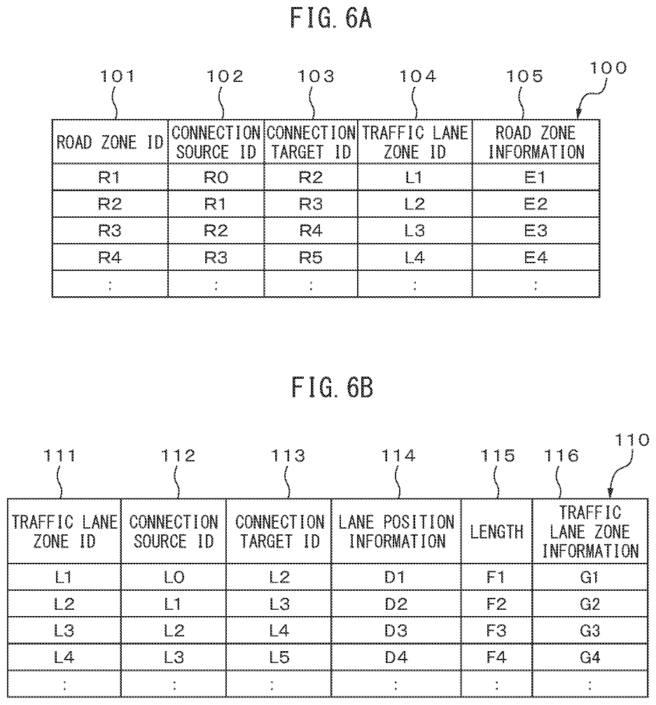

FIG. 6A is a diagram illustrating a road zone management table 100. Multiple road zones in the zone map information are registered in the road zone management table 100. The region from the road zone including the current location of the vehicle 10 to the road zone including the end of the second zone is registered in the road zone management table 100.

The road zone management table 100 has a road zone ID column 101, a connection source ID column 102, a connection target ID column 103, a lane zone ID column 104 and a road zone information column 105. Identification information for identifying road zones is registered in the road zone ID column 101. Identification information for the road zone of the connection source is registered in the connection source ID column 102. Identification information for the road zone of the connection target is registered in the connection target ID column 103. Identification information for identifying traffic lanes in the road zone is registered in the lane zone ID column 104. Information representing identification information for roads in which road zones appear, the locations of road zones, and the types and locations of road features and structures, as well as the legal speed limits of roads, are registered in the road zone information column 105.

FIG. 6B is a diagram illustrating a traffic lane zone management table 110. Multiple traffic lane zones in the zone map information are registered in the traffic lane zone management table 110. The traffic lane zone from the traffic lane zone including the current location of the vehicle 10 to the traffic lane zone including the end of the second zone is registered in the traffic lane zone management table 110.

The traffic lane zone management table 110 has a lane zone ID column 111, a connection source ID column 112, a connection target ID column 113, a lane position information column 114, a length column 115 and a traffic lane zone information column 116. Identification information for identifying traffic lane zones is registered in the lane zone ID column 111. Identification information for the traffic lane zone of the connection source is registered in the connection source ID column 112. Identification information for the traffic lane zone of the connection target is registered in the connection target ID column 113. Multiple points of lane position information items representing lane marking lines in traffic lane zones are registered in the lane position information column 114. The lengths of the lane marking lines in the traffic lane zones are registered in the length column 115. Identification information for the traffic lanes appearing in the traffic lane zones, and the locations of the traffic lane zones, are registered in the traffic lane zone information column 116.

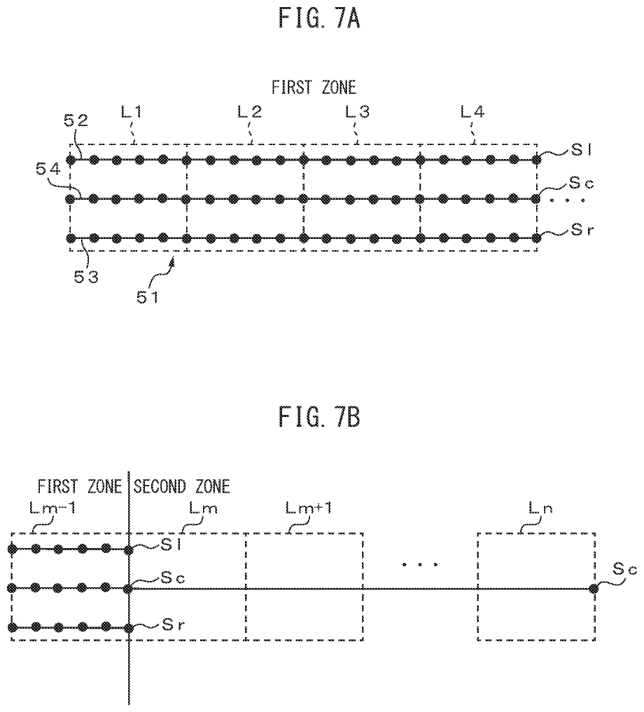

FIG. 7A is a diagram showing several traffic lane zones L1 to L4 of the first zone D1. In the traffic lane zone management table 110, the traffic lane 51 of the first zone D1 is represented as a series of traffic lane zones.

The traffic lane 51 is delineated by a left lane marking line 52 and a right lane marking line 53. In the traffic lane zone management table 110, the left lane marking line 52 is represented as a series of lane position information items of multiple points Sl representing the left lane marking line 52. Likewise, the right lane marking line 53 is represented as a series of lane position information items of multiple points Sr representing the right lane marking line 53. One lane marking line (traffic lane) is thus represented by a series of multiple lane position information items. The traffic lane zone management table 110 also includes a series of lane position information items of multiple points Sc representing the center line 54 of the traffic lane 51.

The lane position information for the points Sl, lane position information for the points Sr and lane position information for the points Sc, for each traffic lane zone, are registered in the lane position information column 114 of the traffic lane zone management table 110 for the first zone D1.

In the traffic lane zone management table 110, the points Sl representing the left lane marking line 52, the points Sr representing the right lane marking line 53 and the points Sc representing the center line 54 are registered in the lane position information column 114 for each traffic lane zone in the first zone D1, in a number allowing the automatic control device 14 to cause the vehicle 10 to travel along the traffic lane 51.

The automatic control device 14 generates a driving plan based on the lane position information for the left lane marking line 52 and right lane marking line 53 registered in the lane position information column 114. The automatic control device 14 may also refer to the lane position information for the center line 54 of the traffic lane to generate the driving plan.

FIG. 7B is a diagram showing multiple traffic lane zones Lm to Ln of the second zone D2. In the traffic lane zone management table 110, the traffic lane 51 of the second zone D2 is also represented as a series of traffic lane zones. The traffic lane zone Lm is the start of the second zone D2, and the traffic lane zone Ln is the end of the second zone D2.

Lane position information for the second zone D2 is registered only in the lane position information column 114 of the traffic lane zone Ln at the end position of the second zone D2, in the traffic lane zone management table 110.

A lane position information item for a point Sc representing the center line 54 of the traffic lane 51 is registered in the lane position information column 114 for the traffic lane zone Ln. Specifically, a lane position information item for the point Sc at the end location of the traffic lane zone Ln is registered in the lane position information column 114 for the traffic lane zone Ln. A lane position information item representing the location of a point Sr of the right lane marking line may also be registered in the lane position information column 114 for the traffic lane zone Ln. In addition, a lane position information item representing the location of a point Sl of the left lane marking line may be registered in the lane position information column 114 for the traffic lane zone Ln.

In the traffic lane zone management table 110, no lane position information is registered in the lane position information column 114 for the traffic lane zone Lm at the start of the second zone D2 up to the traffic lane zone Ln−1 (one before the end). This can greatly reduce the volume of lane position information for the second zone D2 stored in the memory 22.

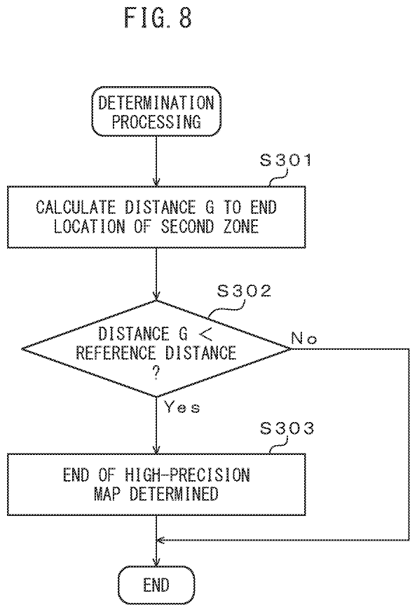

Determination processing by which the map information storage device 11 determines the end position of the region where map information is provided, based on lane position information for the end position of the second zone D2, will now be explained with reference to FIG. 8.

FIG. 8 is an example of an operation flow chart for determination processing by the map information storage device 11 of the embodiment. The map information storage device 11 carries out determination processing according to the operation flow chart shown in FIG. 8, each time zone map information is newly received.

First, the calculating unit 233 calculates the distance G from the current location of the vehicle 10 up to the end of the second zone D2 (step S301). The end position of the traffic lane zone Ln at the end of the second zone D2 is represented by lane position information registered in the traffic lane zone management table 110. The only lane position information registered in the traffic lane zone management table 110 for the second zone D2 is for the traffic lane zone at the end of the second zone D2. The calculating unit 233 refers to the length column 115 in the traffic lane zone management table 110 stored in the memory 22, and calculates the distance G to be the sum of each of the lengths of the traffic lane zones between the start of the first zone D1 and the end of the second zone, for the traffic lane 51 in which the vehicle 10 is traveling. The distance G also includes the length of the traffic lane zone which includes the start of the first zone D1 and the traffic lane zone which includes the end of the second zone.

Next, the determining unit 234 determines whether or not the distance G is shorter than the map end determining distance (step S302). The automatic control device 14 is not able to precisely control the vehicle 10 in a region where high-precision map information is not provided. The map information storage device 11 therefore confirms the end of the region where high-precision map information is provided.

When the distance G is shorter than the map end determining distance (step S302—Yes), the determining unit 234 determines that the end position of the second zone D2 indicates the end position of the region where high-precision map information is provided (step S303), and the series of processing steps is complete. That the distance G is shorter than the map end determining distance means that high-precision map information has not been provided ahead of the end position of the second zone D2.

The determining unit 234 notifies the automatic control device 14 of an end notification indicating that self-driving mode is to end, together with the distance G. The automatic control device 14 transfers to manual driving mode before the vehicle 10 reaches the end of the region where high-precision map information has been provided. In manual driving mode, the vehicle 10 is driven by the driver. The automatic control device 14 may also stop the vehicle 10 before the vehicle 10 reaches the end of the region where high-precision map information has been provided.

When the distance G is not shorter than the map end determining distance (step S302-No), the series of processing steps is complete. That the distance G is not shorter than the map end determining distance means that high-precision map information has been provided ahead at the location at the map end determining distance from the current location of the vehicle 10. The automatic control device 14 is able to drive the vehicle 10 in self-driving mode.

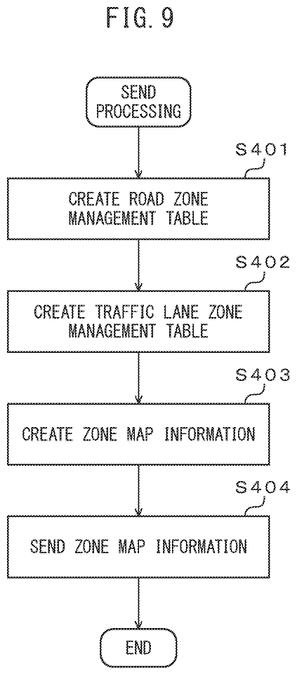

Processing by the server 70 for map information storage processing will now be explained with reference to FIG. 9. FIG. 9 is an example of an operation flow chart for send processing by the server 70. The server 70 carries out send processing according to the operation flow chart shown in FIG. 9, each time a send request is received from the map information storage device 11.

The control unit 341 refers to the map information 321 stored in the storage device 32, based on the current location P of the vehicle 10 and navigation route R, and generates a road zone management table (step S401). The map information 321 includes navigation map and high-precision map information.

The control unit 341 refers to the navigation route R and creates a road zone management table for the road from the current location P of the vehicle 10 to the location of the map end determining distance. In the navigation map, roads are represented as multiple road links connected by nodes. The road from the current location P of the vehicle 10 to the location of the map end determining distance is represented by a series of multiple road links.

The control unit 341 generates a road zone management table representing the road zone from the current location P of the vehicle 10 to the location of the map end determining distance, in association with the road zones of the high-precision map information, for each of the multiple road links in the navigation route R.

Based on the high-precision map information, the control unit 341 then refers to the lane zone ID column of the road zone management table and creates a traffic lane zone management table for the road from the current location P of the vehicle 10 to the location of the map end determining distance (step S402).

The control unit 341 then creates zone map information having the road zone management table, the traffic lane zone management table, and the high-precision map information associated with each table (step S403). For the first zone D1, the control unit 341 creates the zone map information so as to include lane position information items in the number necessary to control the vehicle 10. Specifically, the control unit 341 creates a traffic lane zone management table so as to include lane position information items in the same number as the lane position information items included in the high-precision map information.

For the second zone D2, the control unit 341 creates zone map information to include lane position information items in the number necessary to verify the end position of the region where high-precision map information is provided, and also creates zone map information to include lane position information items in less than the number necessary to control the vehicle 10.

Specifically, the control unit 341 creates a traffic lane zone management table so as to include only lane position information for the traffic lane zone of the end position of the second zone D2. For example, the control unit 341 creates a traffic lane zone management table so as to include only lane position information for the center line of the traffic lane zone of the end position of the second zone D2.

However, it is sometimes occurs that high-precision map information has not been provided up to the location ahead of the current location P of the vehicle 10 by the map end determining distance. In such cases, it may be that high-precision map information has been provided for the first zone but high-precision map information has only been provided for part of the second zone. The control unit 341 therefore creates a road zone management table and a traffic lane zone management table based on the map information up to the end of the region where high-precision map information has been provided. The end of the zone map information for the second zone D2 coincides with the end of the region where high-precision map information is provided. Creation of a traffic lane zone management table by the control unit 341 for the second zone D2, so as to include only lane position information for the traffic lane zone at the end of the second zone D2, is the same as described above.

The control unit 341 then sends the zone map information to the map information storage device 11 (step S404), and the series of processing steps is complete.

As explained above, the map information storage device of the embodiment can store map information with fewer items of information needed for verifying the location of the end position of a region where high-precision map information is provided.

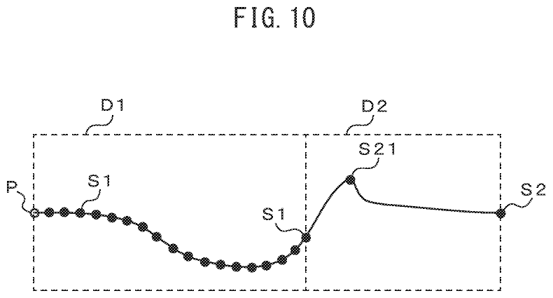

A modified example of the map information storage device 11 of the embodiment will now be described with reference to FIG. 10. FIG. 10 is a diagram illustrating a modified example of a map information storage device 11 of the embodiment.

In this modified example, as the second zone D2, the lane position information includes curvature at a location of a traffic lane which has curvature exceeding a predetermined threshold. The map information storage device 11 sends the current speed of the vehicle 10 to the server 70, together with a send request for zone map information. The server 70 determines the presence or absence of a traffic lane location where the vehicle 10 shows that lateral acceleration exceeding a predetermined reference value occurs, based on the speed of the vehicle 10 and on the navigation route R and high-precision map information. When a traffic lane location where lateral acceleration exceeding the predetermined reference value occurs, the server 70 adds lane position information including the curvature at the location of the traffic lane to the zone map information for the second zone D2. A traffic lane location where a curvature radius is provided may also be referred to as a “sharp curve position”.

In the example shown in FIG. 10, for the second zone D2, the lane position information for point S21 at the sharp curve position is stored in the memory 22 of the map information storage device 11 together with the end point S2. The map information storage device 11 may also store lane position information for points other than those used to verify the end of the region where high-precision map information is provided.

The control unit 231 of the map information storage device 11 refers to the zone map information for the second zone D2, notifying the automatic control device 14 of the sharp curve position and curvature, if lane position information containing a curvature exists.

The automatic control device 14 generates a driving plan so that lateral acceleration produced by the vehicle 10 is within a predetermined limit when the vehicle 10 has reached the sharp curve position. The automatic control device 14 generates a driving plan for deceleration in advance, if it is estimated that the lateral acceleration produced by the vehicle 10 will exceed the reference value for continued traveling at the current speed of the vehicle 10.

According to this modified example, the map information storage device 11 can help to ensure safe driving and comfortable running.

The map information storage device, computer program for map information storage and map information storage method of the embodiment described above for the present disclosure may incorporate appropriate modifications that are still within the gist of the invention. Moreover, the technical scope of the disclosure is not limited to these embodiments, and includes the invention and its equivalents as laid out in the Claims.

For example, the method of determining the end position of a region where high-precision map information is provided is not limited to the one used for the embodiment described above. When high-precision map information has not been provided for a location at the map end determining distance, for example, the server may send to the map information storage device the zone map information that does not include lane position information for the end location of the second zone corresponding to the location of the map end determining distance. The zone map information may also have a flag indicating the presence or absence of lane position information for the end location of the second zone. The map information storage device may also determine the end of the region where high-precision map information is provided based on the presence or absence of lane position information for the end of the second zone. In this case, if it has been initially determined that there is no lane position information for the end of the second zone, the determining unit may determine the end of the region where high-precision map information is provided to be the end of the second zone at the determination time prior to the current determination.

In the case of the embodiment described above, the zone map information created by the server was stored by the map information storage device, but as an alternative, the map information storage device may create the zone map information. In this case, the server sends the high-precision map information for the first zone and second zone to the map information storage device. The high-precision map information includes lane position information items in the number necessary for control of the vehicle. The update unit of the map information storage device inputs the high-precision map information for the first zone and second zone. For the first zone, the update unit acquires lane position information items in the number necessary for control of the vehicle, while for the second zone, it acquires lane position information items in the number necessary to verify the end position of the region where map information is provided. For the first zone, the update unit stores in the memory the acquired lane position information items in the number necessary for control of the vehicle, while for the second zone, it stores in the memory the acquired lane position information items in the number necessary to verify the end of the region where map information is provided. The update unit is an example of an acquisition unit or an input device. When high-precision map information has not been provided up to a point within the second zone, the update unit creates zone map information based on map information up to the end where high-precision map information has been provided.

In the case of the embodiment described above, traffic lane information for the end position of the center line of the traffic lane zone at the end of the second zone was stored in the memory, as lane position information necessary for verifying the end position of the region where map information is provided. However, the memory may store any of the lane position information items for the end positions of the left lane marking line, right lane marking line and center line, for the traffic lane zone at the end of the second zone. In such cases, the map information storage device verifies the end position of the region where map information is provided based on any of the lane position information items for the end positions of the left lane marking line, right lane marking line and center line.

1. A map information storage device that stores map information which includes information relating to traffic lanes shown as a series of multiple lane position information items, and the map information storage device comprises:
a storage device that stores lane position information items in a number necessary for control of a vehicle, for a first zone oriented from a current location of the vehicle toward a traveling direction of the vehicle, and stores lane position information items in a number necessary to verify the end of a region where map information is provided and in a number less than the number necessary for control of the vehicle, for a second zone oriented from an end of the first zone toward the traveling direction of the vehicle.

2. The map information storage device according to claim 1, wherein the storage device stores lane position information representing left and right lane marking lines delineating a traffic lane, for the first zone, and stores lane position information representing any lines from among the left lane marking line and right lane marking line delineating the traffic lane, and a center line representing the center of the traffic lane, for the second zone.

3. The map information storage device according to claim 2, wherein the storage device stores information representing a distance from the end of the first zone to an end of the second zone represented by the lane position information items, and
the map information storage device further comprises:
a processor configured to determine that the end of the second zone is the end of the region where map information is provided, when a distance from the current location of the vehicle to the end of the second zone is less than a predetermined reference distance.

4. The map information storage device according to claim 3, wherein the traffic lanes for the first zone and second zone are represented by a series of traffic lane zones, and
the storage device stores each of lengths of the traffic lane zones, and a distance from a start of the first zone to the end of the second zone is represented as sum of each of the lengths of the traffic lane zones between the start of the first zone and the end of the second zone.

5. The map information storage device according to claim 1, wherein the lane position information of the second zone includes curvature at a location of the traffic lane having curvature exceeding a predetermined threshold.

6. The map information storage device according to claim 1, further comprising:
an input device that inputs lane position information items in the number necessary for control of the vehicle for the first zone, and inputs lane position information items in the number necessary to verify the end of the region where map information is provided, for the second zone, and
wherein the storage device stores the lane position information items in the number necessary for control of the vehicle input by the input device for the first zone, and stores the lane position information items in the number necessary to verify the end of the region where map information is provided and in the number less than the number necessary for control of the vehicle, input by the input device, for the second zone.

7. The map information storage device according to claim 1, further comprising:
a processor configured to
input lane position information items in the number necessary for control of the vehicle for the first zone and second zone,
acquire lane position information items in the number necessary for control of the vehicle for the first zone, and
acquire lane position information items in the number necessary to verify the end of the region where map information is provided, for the second zone, and
wherein the storage device stores the acquired lane position information items in the number necessary for control of the vehicle, for the first zone, and stores the acquired lane position information items in the number necessary to verify the end of the region where map information is provided and in the number less than the number necessary for control of the vehicle, for the second zone.

8. A computer-readable, non-transitory storage medium storing a computer program for map information storage in which map information which includes information relating to traffic lanes shown as a series of multiple lane position information items is stored, and causes a processor to execute a process and the process comprises:
inputting lane position information items in a number necessary for control of a vehicle for a first zone oriented from a current location of the vehicle toward a traveling direction of the vehicle, and inputting lane position information items in a number necessary to verify an end of a region where map information is provided, for a second zone oriented from an end of the first zone toward a traveling direction of the vehicle; and
storing the lane position information items in the number necessary for control of the vehicle for the first zone in a storage unit, and storing the lane position information items in a number necessary to verify the end of the region where map information is provided and in a number less than the number necessary for control of the vehicle, for the second zone, in the storage unit.

9. A map information storage method for storage of map information which includes information relating to traffic lanes shown as a series of multiple lane position information items, which is carried out by a map information storage device and the method comprises:
inputting lane position information items in a number necessary for control of a vehicle for a first zone oriented from a current location of the vehicle toward a traveling direction of the vehicle, and inputting lane position information items in a number necessary to verify an end of a region where map information is provided, for a second zone oriented from an end of the first zone toward a traveling direction of the vehicle; and
storing the lane position information items in the number necessary for control of the vehicle for the first zone in a storage unit, and storing the lane position information items in a number necessary to verify the end of the region where map information is provided and in a number less than the number necessary for control of the vehicle, for the second zone, in the storage unit.
